(19) United States
(12) Patent Application Publication
(10) Pub. No.: US 2006/0119543 A1
(43) Pub. Date: Jun. 8, 2006

(54) Emissive circuit capable of saving power

(75) Inventor: Shuo-Hsiu Hu, Tainan City (TW)

Correspondence Address: SQUIRE, SANDERS & DEMPSEY L.L.P, 600 HANSEN WAY, PALO ALTO, CA, 94304-1043, US

(73) Assignee: AU Optronics Corporation, Hsinchu (TW)

(21) Appl. No.: 11/142,171

(22) Filed: May 31, 2005

(30) Foreign Application Priority Data
Dec. 3, 2004 (TW) 93137390

(51) Int. Cl. G09G 3/12

(52) U.S. Cl. 345/45

(57) ABSTRACT

The invention provides an emissive circuit capable of saving power. According to the total consumed current of the pixel units, the impedance device is electrically connected to the power supply end and the driving device and automatically adjust the total consumed current. Thus, it physically reduces power fluctuation and saves power consumption but not influences the display quality.

### BACKGROUND OF THE INVENTION

1. Field of the Invention

The present invention generally relates to an emissive circuit capable of saving power, and more particularly, relates to a method and an organic light emitting diode circuit capable of saving power.

2. Description of the Prior Art

Since the emissive display has advantages such as a thin design, high color saturation, self-emission, fast display and power saving etc., it has been regarded as one of the next generation flat-display techniques for replacing liquid crystal displays (LCDs). Organic electroluminescence displays (OELDs) are one of the emissive techniques; sometimes it is also called organic light emitting diodes (OLEDs). This technique not only has similar advantages of liquid crystal displays (LCDs) but it also has similar advantages of the light emitting diodes (LEDs).

FIG. 1 shows a schematic diagram illustrating a traditional circuit for a pixel unit of an OLED. In a pixel unit 100, the gate G of the P type thin-film transistor (P-TFT) 101 inputs the data signal Vdata, and the P-TFT forms gate-source potential Vgs to control the Id current for driving the OLED 102 for emitting light. Since the power consumption of the emissive display is directly proportional to the bright area and the emissive brightness, in the frame of display, the brighter the area, the more consumption of the current. In other words, when the display shows a blank frame (dark frame), the consumption current is almost zero. According to the above mentioned, it is easy to know why the emissive display has a large fluctuation in current consumption. For example: the 2 inches OLED display, the display provides 0 mW power when the blank frame shows and 1200 mW power when the full bright frame shows. By designing the display system, the fluctuation of the consumption power regards as a problem. And for the traditional OLED display, it is difficult to design the system with such a large power fluctuation. Furthermore, the large power fluctuation affects the systems life span. As the result, there is a need to provide a kind of emissive display capable of reducing the power fluctuation and reducing the total amount of power consumption.

### SUMMARY OF THE INVENTION

In view of the above-mentioned defects in a traditional display, an object of the present invention provides a method and system for the emissive circuit. The method and circuit can cooperate with the brightness of the emissive area to auto-adjust the brightness of the display panel.

It is an another object of the present invention to provide an emissive circuit and method to save the system power and the circuit and the method does not affect the display quality.

It is a further object of the present invention to provide an emissive circuit and method to substantially reduce the fluctuation of the consumption of power. And it further benefits the design of the whole displaying system.

The invention provides an emissive circuit and method capable of saving power. An impedance device is included and it is electrically connected to the power supply end and the driving circuit. It further, according to the total consumed current of the pixel units adjusts the potential of the pixel unit. In the embodiment of the present invention, the impedance device comprises a resistance device. When the total consumed current of the pixel unit increases, the generated potential difference of the resistance device will reduce the supplied potential of the pixel unit. And the reduced potential lowers the current, which passes through the pixel unit. Since the human eyes do not sense of the variation of the brightness when the potential variation in the limited range, the reduced current would not affect the displaying quality of the display. By the invention, it substantially reduces the fluctuation of the consumed power and saves power.

### BRIEF DESCRIPTION OF THE DRAWINGS

FIG. 1 shows a schematic diagram illustrating a traditional circuit for a pixel unit of an organic electroluminescence display;

FIG. 2 shows a schematic diagram illustrating first embodiment of an emissive display of the present invention; and

FIG. 3 shows a schematic diagram illustrating second embodiment of an emissive display of the present invention.

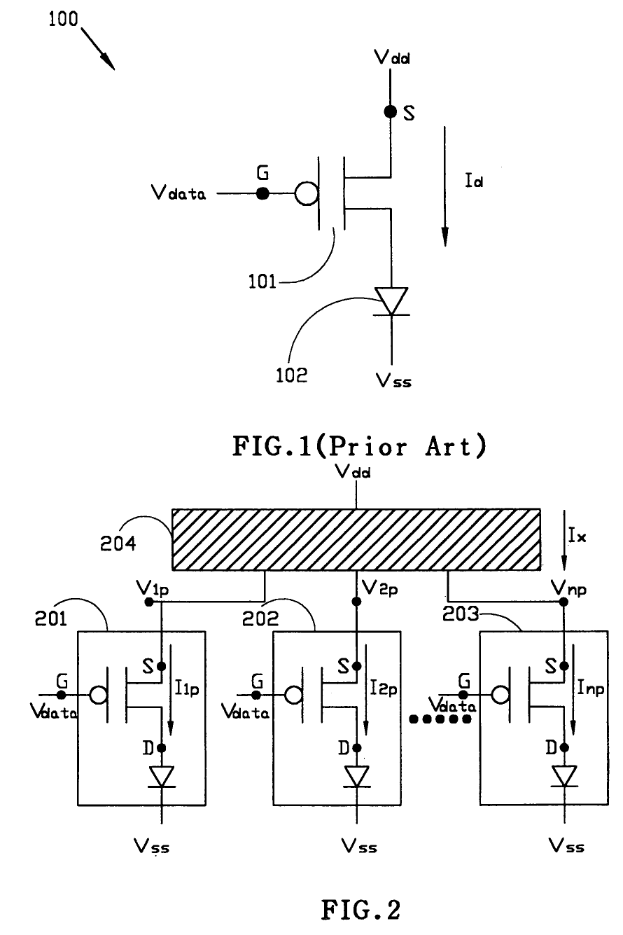

### DESCRIPTION OF THE PREFERRED EMBODIMENTS

The following describes the present invention and in the following description, it does not include all the flow and operation in detail for the emissive circuit and the method capable of saving power. Otherwise, for easy understanding and clarifying the invention, the parts of the illustration are not depicted in corresponding scale. Some scales and related ratios have has been exaggerated, and the unrelated parts have not fully shown for the concise drawing. However, except for the detailed description, the invention can be widely applied in other inventions. And the invention is not limited here as stated in the claims.

Referring to FIG. 2, it shows a schematic diagram illustrating the first embodiment of an emissive display of the present invention. In order to clarify the present invention, only three pixel units 201, 202, and 203 are depicted here. However, the technician who is familiar in the field knows how to combine all the pixel units to form a dots array display. The invention provides multiple pixel units, such as pixel unit 201, 202, and 203 and an impedance device 204. And each pixel unit 201, 202, and 203 has each own self-emissive device and driving device connecting in series. In the present embodiment, the emissive device is an organic light emitting diode (OLED). And the driving device can be a three ends device, such as a P type thin film transistor (P-TFT) and it can further be a low temperature poly-silicon (LTPS), the amorphous silicon (a-Si) or the organic thin film transistor. In the pixel unit, the cathode of the organic light emitting diode is electrically connected to the power end Vss and the anode of the organic light emitting is electrically connected to the drain (D) of the driving P-TFT. The gate (G) of the driving P-TFT is for receiving data, which is inputting signal Vdata. And the source (S) of the driving P-TFT is electrically connected to the impedance device 204. The impedance device 204 seriates the supplied power, Vdd, and the pixel unit 201, 202, and 203. The impedance device 204 can be a resistor or a resistor composed by a transistor.

The following describes the operation of the circuit. In the first embodiment of an emissive display of the present invention, the S of the driving P-TFT of each pixel unit 201, 202, and 203 has potential V₁ₚ, V₂ₚ, and Vₙₚ, respectively. And each current passing through each pixel unit 201, 202, and 203 is I₁ₚ, I₂ₚ, and Iₙₚ, respectively. By the structure of the circuit, Iₓ is the total current, which is the sum of I₁ₚ, I₂ₚ, and Iₙₚ. Additionally, the amount of the gate-source potential |Vgs| of each driving transistor determines the current amount I₁ₚ, I₂ₚ, and Iₙₚ. of each pixel unit. When the bright area is getting more in the frame, the total current Iₓ increases. And the result is that the potential of both ends of the impedance device 204 increases. Therefore, the potential of the source (S) V₁ₚ, V₂ₚ, and Vₙₚ, of each driving P-TFT in the pixel unit 201, 202, and 203 decreases. The potential of the S decreasing induces the gate-source potential |Vgs| decrease and the current I₁ₚ, I₂ₚ, and Iₙₚ, of each pixel unit decrease, too. As the result, the feedback loop is formed. In other words, the total current is directly proportional to the potential of the impedance device itself and is also directly proportional to the brightness of the emissive device. Furthermore, the total current of passing through the impedance device is inversely proportional to the potential of drain (D) of the driving transistor. By the impedance of the present invention, it substantially reduces the fluctuation of the consumption of power. And when displaying a large bright area or a large white area in the display, the display will automatically reduce the output brightness for saving power. Since the human eyes does not sense the brightness reducing in a limited range and the reduced brightness would not affect the displaying quality of the display.

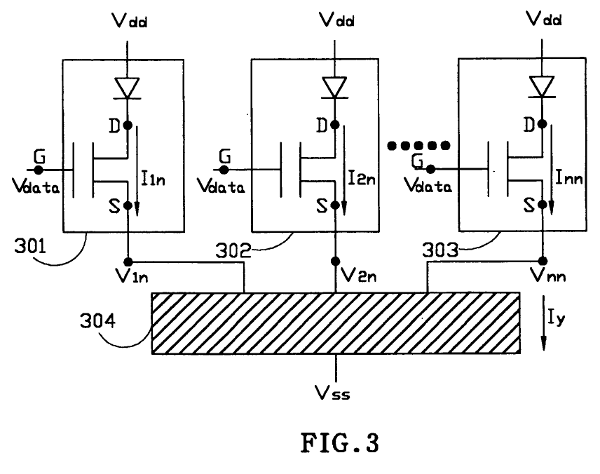

Referring to FIG. 3, it shows a schematic diagram illustrating a second embodiment of an emissive display of the present invention. Similarly, in order to clarify the present invention, only three pixel units 301, 302, and 303 are depicted here. However, the technician who is familiar in the field knows how to combine all the pixel units to form a dots array display. The present invention provides multiple pixel units, such as pixel unit 301, 302, and 303 and an impedance device 304. And each pixel unit 301, 302, and 303 has each own self-emissive device and driving device. In the present embodiment, the emissive device is OLED and the OLED is electrically connected to the driving device, wherein the driving device includes N-TFT. The difference from the first embodiment is the anode of the OLED is electrically connected to the power end, Vdd, and the cathode is electrically connected to the drain (D) of the driving N-TFT. The gate (G) of the driving N-TFT is for receiving data, which is inputting signal Vdata. And the source (S) of the driving N-TFT is electrically connected to the impedance device 304. The impedance device 304 is similar to the previous embodiment described. The impedance device 304 can be a resistor and can be a transistor-composed resistor. The impedance device 304 seriates the supplied power, Vss, and the pixel units 301, 302, and 303.

The operation of the circuit is similar to the first embodiment. In the second embodiment of the present invention, the source (S) potential of the driving N-TFT of each pixel unit 301, 302, and 303 are V₁ₙ, V₂n, and Vₙₙ, respectively. By the structure of the circuit, I_{y} is the total current and it is equivalent to the total of I₁ₙ, I₂ₙ, and Iₙₙ. In addition, the amount of Vgs potential of each driving transistor determines the current amount (I₁ₙ, I₂ₙ, and Iₙₙ) of each pixel unit. When the displaying frame has bigger bright area, the total current I_{y} increases more and it also causes the potential of both ends of the impedance device to be increased. Therefore, the potential of the source (S) V₁ₙ, V₂ₙ, and Vₙₙ of each driving N-TFT in pixel unit 301, 302, and 303 decrease. The potential of the S decreasing induces the gate-source potential |Vgs| decreases and the current I₁ₙ, I₂ₙ, and Iₙₙ of each pixel unit decreases, too. As the result, the feedback loop is formed. By the impedance of the present invention, it substantially reduces the fluctuation of the consumption of power. And when displaying a large bright area or a large white area in the display, the display will automatically reduce the output brightness for saving power. Since the human eyes do not sense the brightness reducing in a limited range and the reduced brightness would not affect the displaying quality of the display.

In the above-mentioned embodiment, the impedance device is placed between the source (S) of the pixel unit and the steady potential point of the supply circuit. The impedance device can be made as the pixel unit on the glass substrate and both of them can be made at the same time. However, the impedance device also can be made as an external module. The impedance device regards the demand of the customer and the preferred resistor range is around 1 to 25 Ohm. It is worth to discuss that depending on the gate-source potential Vgs is better than depending on the drain-source potential Vds to control the brightness of an OLED. It is generally known, when the transistor is working on saturation area, the current Id of the transistor is controlled by the gate-source potential Vgs.

In order to clarify the performance of the present invention, the following description utilizes the first embodiment (as shown in FIG. 2) to describe (I) the traditional display and (II) the present invention display with impedance device.

(I) The Traditional Display

If the frame full blank (black): Vdd sets 3V, Vg=Vdata=3V, the total current Ix=0 mA, since R=0, and (Ix)*R=0V, then Vs=Vdd−(Ix)*R=3V−0V=3V, |Vgs|=0V, finally the total current is 0 mA.
If the frame full bright: Vdd set 3V, Vg=Vdata=0V, the total current Ix=100 mA, since R=0, and (Ix)*R=0V, then Vs=Vdd−(Ix)*R=3V−0V=3V, |Vgs|=3V, finally the total current is 100 mA.
   (II) The Display with Impedance Device
If the frame full blank (black): Vdd sets 3V, Vg=Vdata=3V, the total current Ix=0 mA, since R=0, and (Ix)*R=0V, then Vs=Vdd−(Ix)*R=3V−0V=3V, |Vgs|=0V, finally the total current is 0 mA.
If the frame full bright: Vdd set 3V, Vg=Vdata=0V, the total current Ix=100 mA, since R=5, and (Ix)*R=0.5V, then Vs=Vdd−(Ix)*R=3V−0.5V=2.5V, |Vgs|=2.5V, finally the total current is 80 mA.

According to above data, in traditional display, if the frame is full bright, the total current is 100 mA and the brightness is about 150 nits. Otherwise, in the display with impedance device if the frame is at full brightness, the total current is 80 mA and the brightness is about 120 nits. That is to say, the total current of the full bright frame saves 20 mA. Furthermore, the human eyes cannot distinguish the frame of a large area of brightness in 150 nits or in 120 nits. The quality of displaying is not affected. By present invention, it substantially reduces the fluctuation of the consumption of power and saves the power consumption.

Although the description discloses the preferred embodiment herein, it is not limit the spirit of the present invention. It is intended that the specification and examples to be considered as exemplary only, with a true scope and spirit of the present invention being indicated by the following claims.

What is claimed is:

1. An emissive circuit, comprising:
a plurality of driving devices, each of said driving devices having a first end, a second end, and a third end;
a plurality of self-emissive devices, each of said self-emissive devices being electrically connected to the third end of respective driving devices; and
an impedance device, electrically connected to said second end of respective driving devices, for adjusting a potential difference between said first end and said second end so as to adjust the brightness of each of said self-emissive devices.

2. The emissive-circuit according to claim 1, wherein each of said self-emissive devices comprises an organic light emitting diode (OLED).

3. The emissive circuit according to claim 1, wherein each of said self-emissive devices comprises an anode end electrically connected to the individual third end.

4. The emissive circuit according to claim 1, wherein each of said driving devices comprises a P type thin-film-transistor (P-TFT) or an N type thin-film-transistor (N-TFT).

5. The emissive circuit according to claim 1, wherein each of said driving devices is electrically connected to one of said self-emissive devices in series.

6. The emissive circuit according to claim 1, wherein the current through said impedance device is substantially identical to said current provided to each of said self-emissive devices.

7. The emissive circuit according to claim 1, wherein said impedance device comprises a resistor.

8. The emissive circuit according to claim 7, wherein said resistor has a resistor value substantially in the range of about 1 to 25 ohms.

9. The emissive circuit according to claim 1, wherein said impedance comprises a transistor.

10. An emissive circuit having a power supply end with a first potential, comprising:
at least one driving device having a first end, a second end, and a third end;
an impedance device electrically connected to said second end, said power supply end and said second end forming a second potential; and
at least one self-emissive device electrically connected to said third end, wherein the brightness of said at least one self-emissive device is adjusted according to the potential difference between said first end and said second end.

11. The emissive circuit according to claim 10, wherein said second potential is the difference between said first potential and the potential of said impedance device.

12. The emissive circuit according to claim 10, wherein said at least one self-emissive device comprises an organic light emitting diode (OLED).

13. The emissive circuit according to claim 10, wherein said at least one self-emissive device comprises an anode end electrically connected to said third end.

14. The emissive circuit according to claim 10, wherein said at least one driving device comprises a P type thin-film-transistor (P-TFT) or an N type thin-film-transistor (N-TFT).

15. The emissive circuit according to claim 10, wherein said at least one driving device is electrically connected said at least one self-emissive device in series.

16. The emissive circuit according to claim 10, wherein the current through said impedance device is substantially identical current provided to said at least one self-emissive device.

17. The emissive circuit according to claim 10, wherein said impedance device comprises a resistor.

18. The emissive circuit according to claim 17, wherein said resistor has a resistor value substantially in the range of about 1 to 25 ohms.

19. The emissive circuit according to claim 10, wherein said impedance device comprises a transistor.

20. A method for adjusting power provided to an emissive display having a power end electrically connected to a plurality of driving devices, each of said driving devices having a first end, a second end and a third end, a plurality of self-emissive devices, each of said self-emissive is electrically connected to said third end, and two ends of an impedance device are electrically connected to said second end and said power end, respectively, said method comprising:
driving said plurality of self-emissive devices according to potential of said first end and potential of said third end;
providing a total current to said plurality of self-emissive devices according to the self-emissive devices emitting; and
adjusting the potentials of the two ends of said impedance device according to said total current.

21. The method according to claim 20, wherein the brightness of said plurality of self-emissive devices is substantially proportional to said total current.

22. The method according to claim 20, wherein said total current is substantially proportional to said potentials of the two ends of said impedance device.
